(19) United States
(12) Patent Application Publication
(10) Pub. No.: US 2008/0066936 A1
(43) Pub. Date: Mar. 20, 2008

(54) Snowplow To 3 Point Hitch Adapter

(76) Inventor: Ralph L. Lavin, Gilmanton Iron Works, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/468,549

(22) Filed: Aug. 30, 2006

(51) Int. Cl. A01B 59/06

(52) U.S. Cl. 172/439

(57) ABSTRACT

A snowplow frame to three-point hitch adapter includes an adapter frame having a first and a second side, each side generally parallel to one another. The first side includes a number of interconnection points sized and located to generally match the interconnection points between a snowplow and a snowplow frame, while the second side includes a number of interconnection points sized and located to generally match with the interconnection points on a three-point hitch configured tractor implement.

### TECHNICAL FIELD

The present invention relates to tractor implements and more particularly, to an adapter for interfacing traditional tractor three-point hitch implements to a snow plow frame.

### BACKGROUND INFORMATION

In those areas of the country which received a reasonable amount of snowfall, many trucks are equipped with snowplows to handle snow removal. Even in those areas of the country where there is no snow fall, trucks are plentiful, easier to get around in than a tractor, and can easy be fitted with a snow plow frame.

A snowplow typically involves several elements. The first includes a method of mounting the snowplow to the frame or body of the truck. The second element includes a method to at least raise and lower the snowplow to either place it in contact with the ground or to raise it from contact with the ground. Finally, most snowplows include a way to disconnect the snow plow blade is self from the remainder of the snowplow frame.

Whenever the snowplow is not being used, the snowplow frame often remains on the truck but is not utilized. Many of the trucks which have a snowplow frame are heavy-duty work trucks which are used for other tasks such as landscaping, road repair, home construction and the like.

Ever since the first tractor was developed, companies have been developing implements or attachments for the tractor. These implements include but are not limited to rakes, blades, rotor tillers, forklift tines, backhoes and the like. Over the years, tractor manufacturers have developed a standardized interface between these implements and a tractor. This interface is commonly referred to as the three point hitch. A three-point hitch provides, as the name implies, three points of attachment between the tractor and the implement: two along the bottom of the implement and one near the top of the implement. The arrangement and spacing between the three points of attachment on a three-point hitch is well known and relatively standardized.

Although tractor implements are relatively inexpensive, tractors, on the other hand, are not. Accordingly, there are many three-point hitch implements which individuals would find useful in various occupations such as landscaping, home construction or even private home ownership but which cannot be used by these individuals because they lack ownership of or access to a tractor. Further, even if you have a tractor, moving a tractor around by driving it or trailering it is certainly more difficult than driving a truck around.

Accordingly, a need exists for an interface or adapter which can be used to allow many if not all standard three-point hitch configured tractor implements to be utilized with a standard snowplow connection on a truck or other vehicle.

### SUMMARY

The present invention features a snowplow frame to three-point hitch adapter, comprising an adapter frame having a first and a second side (also referred to herein as front and back surfaces). The first side is generally parallel to said second side. The first side includes a first plurality of interconnection points which are sized and located to generally match the interconnection points between a snowplow and a snowplow frame. The second side includes a second plurality of interconnection points which are sized and located to generally match the interconnection points of a three-point hitch.

In the preferred embodiment, the first plurality of interconnection points include at least three pin receivers located on the first side of the frame. The second plurality of interconnection points may include two three-point hitch interconnection points proximate a lower region of the second side of the frame and a third interconnection point proximate a top region of said second side of said frame. The second plurality of interconnection points may include quick connect attachment points adapted to interconnect with the three-point hitch interconnection points provided on a tractor implement. In another embodiment, the adapter may include front and back generally parallel surfaces as well as first and second generally parallel side portions connecting the front and back surfaces. In this embodiment, the second plurality of interconnection points which are sized and located to generally match the interconnection points of a three-point tractor hitch may be located on the first and second generally parallel side portions.

### BRIEF DESCRIPTION OF THE DRAWINGS

These and other features and advantages of the present invention will be better understood by reading the following detailed description, taken together with the drawings wherein:

FIG. 1 is schematic representation showing the snowplow to three-point hitch adapter according to the present invention and exploded view between a snow plow frame and a three-point hitch implement;

FIG. 2 is a front schematic view of the snowplow to three-point hitch adapter of the present invention showing the three-point hitch interface; and

FIG. 3 is a schematic view of the snowplow to three-point hitch adapter of the present invention showing the snowplow interface.

### DETAILED DESCRIPTION OF THE PREFERRED EMBODIMENTS

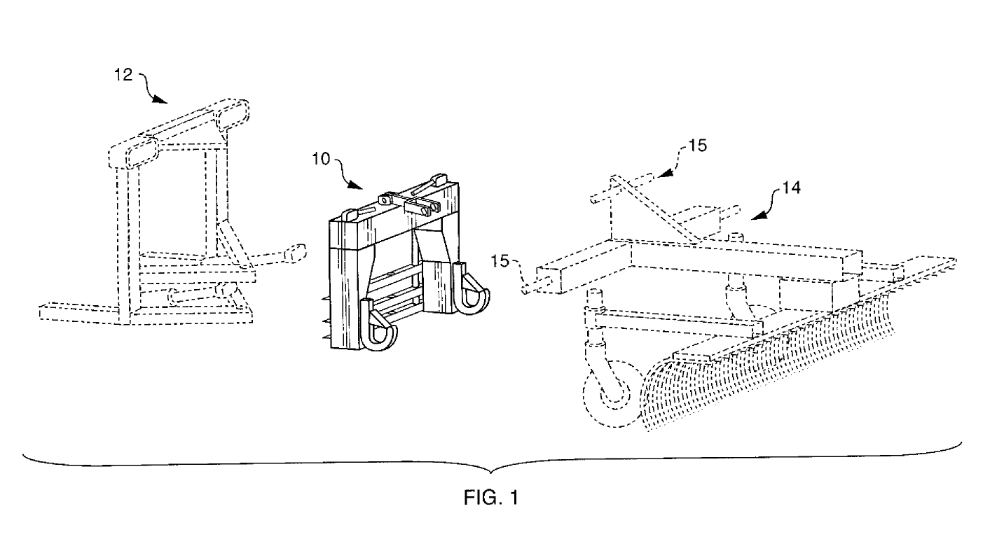

The present invention features an adapter or interface 10, FIG. 1 which serves as an adapter between a snow plow frame 12 and a tractor implement 14 having a standard, three-point hitch connection. For purposes of the present explanation, a three-point hitch connection is presumed to mean a category 1 three point hitch connection although this is not a limitation of the present invention as other categories of three point hitch connections as well as other multi-point hitch connections are contemplated and are considered within the scope of the present invention.

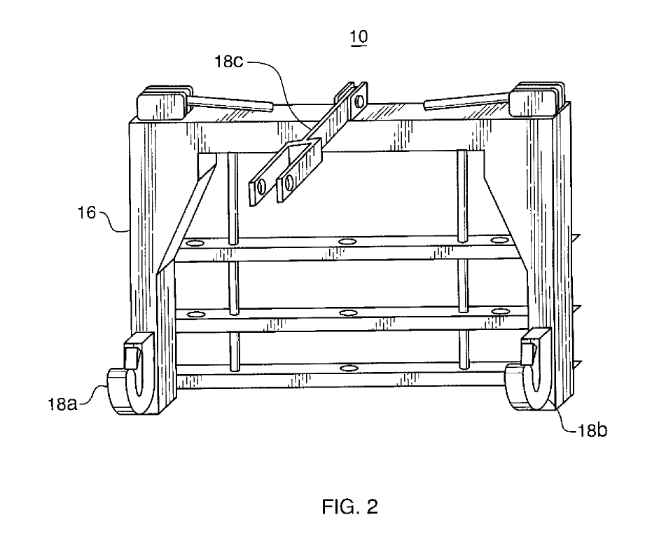

As shown in greater detail and FIG. 2, the snowplow to three-point hitch adapter 10 according to the present invention is a four-sided frame 16. One side of frame 16 (also termed a front surface), as shown and FIG. 2, is sized and adapted to interface with a standard three-point hitch connection on a tractor implement. A standard three-point hitch connection requires 2 connection points 18a, 18b proximate the bottom region of the frame 16 and one connection point 18c proximate the top region of the frame 16. The three-point hitch connection points 18 may be receivers meant to interface with the three-point hitch pins 15, (two of the three of which are shown in FIG. 1), normally found on three-point hitch tractor implements. Alternatively, the connection points 18 may be quick connection type of receivers as might be found on a Land Pride Quick Hitch brand of connection device manufactured by Land Pride division of Great Plains Manufacturing, Inc. or similar device such as the I-Match quick hitch connector manufactured by John Deere.

In another embodiment, the connection points 18a and 18b may be located not on the front surface of the adapter 16 but rather, on the shorter sides connection the front and back larger planer surfaces of the adapter.

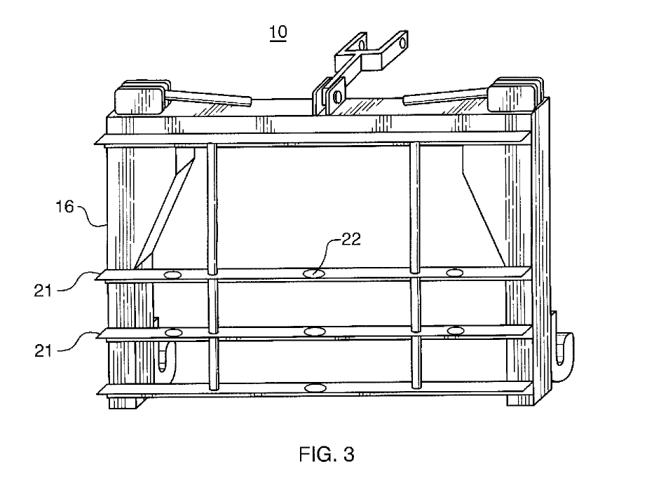

The second side of frame 16 (also terms the rear surface) is shown in FIG. 3 and is one implementation of a snowplow interface in accordance with one aspect of the present invention. This side of the snowplow to three-point hitch adapter 10 includes one or more connection pin connecting holes 22 which connect the interface to the snowplow frame in the same location as would a snowplow blade. The connection pins pass through holes 22 formed in two parallel cross-members 21 which generally span the width of the adapter 10 and in other cross-members as required or desired.

As is well known in the art, a lifting force on a snowplow is provided by a piston connected and/or chain which may be hydraulically or electrically operated. It should be understood that the hydraulics including the piston or hydraulic pump of the snow plow frame may have to be upgraded if the weight of the implement is too much for the existing snow plow piston. It should be further noted and understood that the term snowplow frame includes the type of snowplow frame including the lifting piston that remains generally stationary, in place, on a vehicle as well as the quick connect type of snowplow frames more commonly found today in which the bulk of the frame as well as the lifting cylinder is detached from the vehicle when not in use. In either case, only the actual snow plow itself needs to be removed from the assembly to use the adapter of the present invention.

Accordingly, the present invention provides a novel, low cost, easy to use adapter between a snowplow frame for a vehicle and a three-point hitch tractor implement thereby allowing expanded use of three-point hitch tractor implements on vehicles equipped with a snowplow connection.

Modifications and substitutions by one of ordinary skill in the art are considered to be within the scope of the present invention, which is not to be limited except by the allowed claims and their legal equivalents.

The invention claimed is:

1. A snowplow frame to three-point hitch adapter, comprising:
an adapter frame having a first and a second side, said first side generally parallel to said second side;
said first side including a first plurality of interconnection points, said first plurality of interconnection points sized and located to generally match the interconnection points between a snowplow and a snowplow support frame; and
said second side including a second plurality of interconnection points, said second plurality of interconnection points sized and located to generally match the interconnection points of a three-point hitch.

2. The adapter of claim 1, wherein said first plurality of interconnection points includes at least two pins and two pin receivers located on said first side of said frame.

3. The adapter of claim 1, wherein said second plurality of interconnection points include two three-point hitch interconnection points proximate a lower region of said second side of said frame and a third interconnection point proximate a top region of said second side of said frame.

4. The adapter of claim 1, wherein said second plurality of interconnection points include quick connect attachment points adapted to interconnect with the three-point hitch interconnection points provided on a tractor implement.

5. A snowplow frame to three-point hitch adapter, comprising:
an adapter frame having a first and a second side, said first side generally parallel to said second side;
said first side including a first plurality of interconnection points, said first plurality of interconnection points sized and located to generally match the interconnection points between a snowplow and a snowplow support frame, said first plurality of interconnection points including at least two pins and two pin receivers located on said first side of said frame; and
said second side including a second plurality of interconnection points, said second plurality of interconnection points sized and located to generally match the interconnection points of a three-point hitch, said second plurality of interconnection points including two three-point hitch interconnection points proximate a lower region of said second side of said frame and a third interconnection point proximate a top region of said second side of said frame.

6. A snowplow frame to three-point hitch adapter, comprising:
an adapter frame having front and back generally parallel surfaces as well as first, second and third side portions connecting the front and back surfaces, said first side portion generally parallel to said second side portion;
said back surface including a first plurality of interconnection points, said first plurality of interconnection points sized and located to generally match the interconnection points between a snowplow and a snowplow support frame, said first plurality of interconnection points including at least two pins and two pin receivers located on said first side of said frame; and
said first, second and third side portions each including a three-point hitch interconnection point, said first, second and third interconnection points sized and located to generally match the interconnection points of a three-point hitch, said interconnection points including two, three-point hitch interconnection points proximate a lower region of said first and second side portions of said frame respectively, and a third interconnection point proximate a top region of said frame on said third side portion.
